(19) United States
(12) Patent Application Publication
(10) Pub. No.: US 2006/0043684 A1
(43) Pub. Date: Mar. 2, 2006

(54) Surgical instrument with locking element

(75) Inventors: Brian Barber, Southlake, TX (US); George Valenzuela, Keller, TX (US)

Correspondence Address: HAYNES AND BOONE, LLP, 901 MAIN STREET, SUITE 3100, DALLAS, TX, 75202, US

(73) Assignee: Medtronic, Inc., Minneapolis, MN (US)

(21) Appl. No.: 10/930,139

(22) Filed: Aug. 31, 2004

(51) Int. Cl. B23B 31/12

(52) U.S. Cl. 279/76

(57) ABSTRACT

A surgical instrument and method according to which at least a portion of a collet housing is inserted into a motor case. A locking element locks the collet housing to the motor case and includes a circumferentially-extending channel formed therein and into which a distal portion of the motor case extends.

### FIELD OF THE INVENTION

The present invention relates generally to a surgical instrument and in particular to a surgical instrument with a locking element, and to a method of assembling same.

### BACKGROUND

Many conventional surgical instruments include components that are connected to each other using a locking element. For example, a cylindrical structure, such as a collet for receiving a shaft, may be inserted into a tubular member, such as a motor case for housing a motor to rotate the shaft. An externally-threaded locking element is often used that threadably engages the motor case to lock the collet to the motor case. To maintain the threaded engagement, the locking element may be torqued to a predetermined value and a thread-locking adhesive may be applied to the threads.

However, problems may arise during the operation of a surgical instrument having a locking element configuration that includes one or more threaded engagements. For example, during normal operation, the surgical instrument may experience vibratory loading to such a degree that the locking element disengages from the motor case, increasing the risk of harm to the patient and/or the instrument operator. Also, the surgical instrument may be cleaned and sterilized in an autoclave, resulting in the surgical instrument being subjected to high-temperature cycling that could degrade the thread-locking adhesive so that the adhesive fails to hold the threaded engagement.

TABLE 1

| United States Patent | Publication | | Appl. Ser. |
|---|---|---|---|
| Publication No. | Date | Inventor | No. |
| 2002/0151902 | Feb. 17, 2002 | Riedel et al. | 10/102,762 |
| 2002/0165549 | Nov. 07, 2002 | Owusu-Akyaw et al. | 10/135,608 |
| 2003/0023256 | Jan. 30, 2003 | Estes et al. | 10/200,683 |
| 2003/0163134 | Aug. 28, 2003 | Riedel et al. | 10/164,867 |
| 2003/0229351 | Dec. 11, 2003 | Tidwell et al. | 10/164,880 |
| 2004/0122460 | Jun. 24, 2004 | Shores et al. | 10/326,178 |

| | | |
|---|---|---|
| N/A (Copending Application - | Shores et al. | N/A |
| Attorney Docket No. 31849.52/P- | | |
| 21133.00US) | | |

All references listed in Table 1 are hereby incorporated by reference herein in their respective entireties. As those of ordinary skill in the art will appreciate readily upon reading the Summary of the Invention, Detailed Description of the Preferred Embodiments and Claims set forth below, many of the devices and methods disclosed in the references of Table 1 may be modified advantageously by using the teachings of the present invention.

### SUMMARY OF THE INVENTION

In order to overcome one or more of the above-described problems, and according to an embodiment of the present invention, a surgical instrument is provided that includes a collet housing, at least a portion of which is inserted into a motor case. A locking element locks the collet housing to the motor case. The locking element includes a circumferentially-extending channel formed therein and into which a distal portion of the motor case extends. Thus, the integrity of the connection between the locking element and the motor case is not solely dependent upon one or more threaded engagements.

Further areas of applicability of the present invention will become apparent from the detailed description provided hereinafter. It is understood that various embodiments of the present invention may overcome one or more of the above-described problems. It is further understood that the detailed description is intended for the purpose of illustration only and is not intended to limit the scope of the invention.

### BRIEF DESCRIPTION OF THE DRAWINGS

FIG. 1 is an exploded view of a surgical instrument according to an embodiment of the invention.

FIG. 2 is an exploded view of a portion of the surgical instrument of FIG. 1.

FIG. 3 is a perspective view of a component of the surgical instrument of FIG. 2.

FIG. 4 is a perspective view of the portion of the surgical instrument of FIG. 2.

FIG. 5 is a sectional view of the portion of the surgical instrument shown in FIG. 4 taken along the line 5-5, but having the viewing angle rotated approximately 135 degrees clockwise from the horizontal viewing angle associated with the line 5-5.

FIG. 6A is an enlarged view of a portion of the sectional view shown in FIG. 5, but depicting two components of the surgical instrument in a partially-assembled condition.

FIG. 6B is a view similar to that of FIG. 6A, but depicting another partially-assembled condition between the two components.

FIG. 6C is a view similar to that of FIG. 6B, but depicting a fully-assembled condition between the two components.

### DETAILED DESCRIPTION OF THE PREFERRED EMBODIMENTS

Referring to FIG. 1, the reference numeral 10 refers, in general, to a surgical instrument such as, for example, a dissection tool assembly used to dissect human bone or other tissue. A pneumatic motor 12 having a motor case 14 is connected to a hose assembly 15 that supplies pressurized air to the motor and vents low-pressure exhaust air away from the surgical area. A collet 16 is connected to the distal end of the motor 12, and includes a distal portion 18 and segments 20 and 22. An attachment 24 having a housing 24a is connected to the collet 16 so that the distal portion 18 and the segments 20 and 22 are disposed in the housing. The motor 12, the hose assembly 15, the collet 16 and the attachment 24 are disclosed in detail in co-pending patent application Ser. No. 10/164,880, filed Jun. 7, 2002 (pub. No. 2003/0229351), the disclosure of which is incorporated by reference.

A dissection tool 26 includes a shaft 28 and a surgical element such as a dissection head 30 connected to the distal end of the shaft. The shaft 28 is disposed through the attachment 24 and inserted into and coupled to the collet 16. This coupling of the shaft 28 to the collet 16 is disclosed in detail in co-pending patent application Ser. No. 10/200,683, filed Jul. 22, 2002 (pub. No. 2003/0023256, the disclosure of which is incorporated by reference.

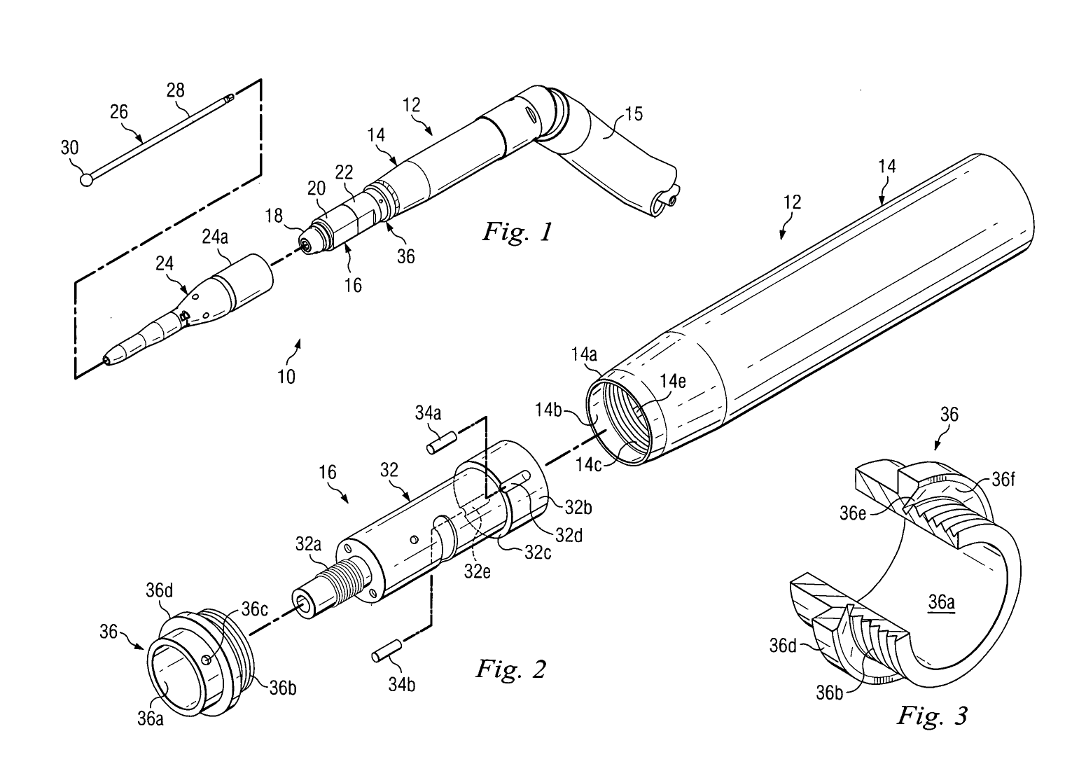

Referring to FIGS. 2 through 3, with continuing reference to FIG. 1, the motor case 14 includes a distal portion 14a having an undercut 14b formed in the inner wall of the housing. An internal threaded portion 14c is also formed in the inner wall of the motor case 14 adjacent the undercut 14b. It is understood that the motor case 14, and particularly the distal portion 14a, may be made out of a material having a relatively low material hardness such as, for example, an aluminum alloy.

The collet 16 further includes a collet housing 32 having a reduced-diameter externally-threaded end portion 32a, and a raised-diameter end portion 32b having a shoulder 32c. Opposed axially-extending slots 32d and 32e are formed in the raised-diameter end portion 32b and receive pins 34a and 34b, respectively.

A cylindrical locking element 36 includes a bore 36a and an external threaded portion 36b. A radially-extending through-opening 36c is formed in the locking element 36 and a ring 36d extends around the locking element between the through-opening and the threaded portion 36b. As more clearly shown in FIG. 3, a channel 36e extends around the locking element 36. The channel 36e is formed in a side wall of the ring 36d and extends in an angular direction towards the bore 36a and away from the threaded portion 36b to define a camming surface 36f for reasons to be described. It is understood that the locking element 36 may be made out of a material having a relatively high material hardness such as, for example, heat treated stainless steel, and that this material hardness may be higher than the material hardness of the motor case 14a.

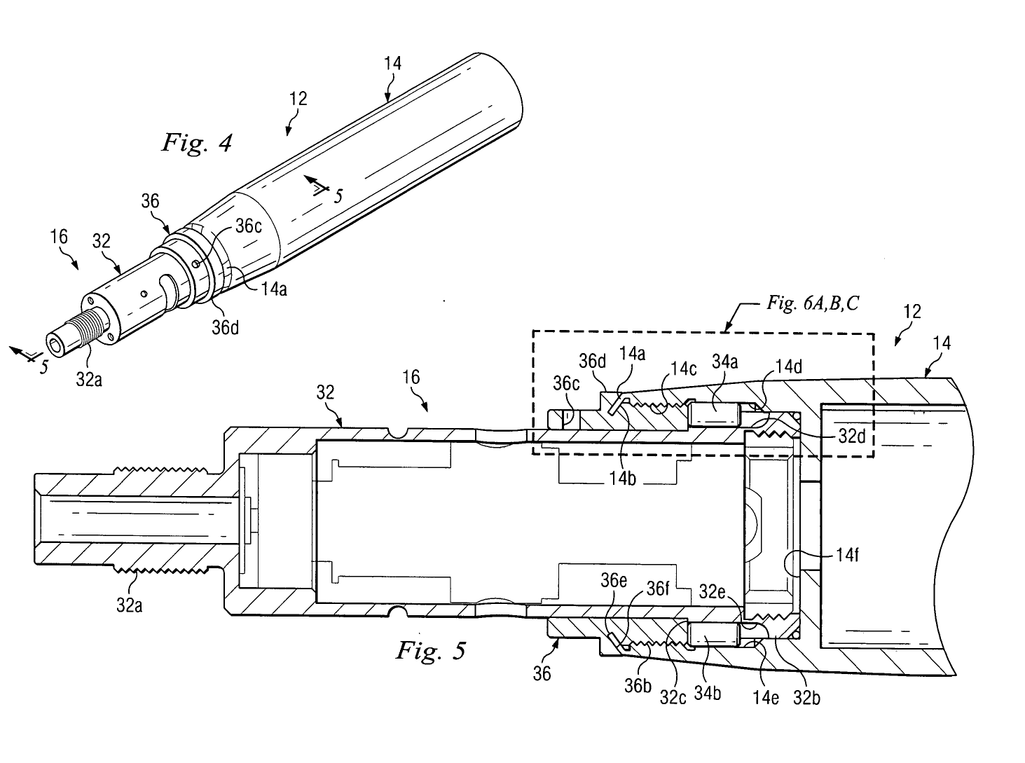

When the collet 16 is assembled with the motor 12, as shown in FIGS. 4 and 5, the raised-diameter end portion 32b of the collet housing 32 is inserted into the motor case 14 and the collet housing extends through the bore 36a of the locking element 36. Although not shown for clarity purposes, it is understood that the collet housing 32 also extends through the segments 20 and 22 (FIG. 1), and that the externally-threaded end portion 32a is threadably engaged with the distal portion 18, as disclosed in the above-incorporated co-pending patent application Ser. No. 10/200,683. It is further understood that the housing 24a of the attachment 24 extends over the distal portion 18, the segments 20 and 22, and the locking element 36, and abuts the ring 36d.

As shown in FIG. 5, opposed axially-extending slots 14d and 14e are formed in the inner wall of the motor case 14 and are circumferentially aligned with the slots 32d and 32e, respectively, so that portions of the pins 34a and 34b extend into the slots 14d and 14e, respectively. An radially-extending inner wall 14f is formed in the motor case 14 and is contacted by the proximal end of the collet housing 32.

The locking element 36 is threadably engaged with the motor case 14 via the threaded portions 36b and 14c, respectively. It is understood that an adhesive, such as Loctite® threadlocker adhesive, may be applied to the threaded portions 36b and 14c. The distal portion 14a is crimped or deformed and extends into the channel 36e. It is understood that the channel 36e may also be filled with adhesive. The distal portion 14a, and the portion of the motor case 14 immediately adjacent the distal portion, are twisted or torqued for reasons to be described in detail below.

It is understood that the collet 16 is represented only by the collet housing 32 for clarity purposes, and that the collet may include additional components such as, for example, components disclosed in detail in the above-incorporated co-pending patent application Ser. No. 10/164,880.

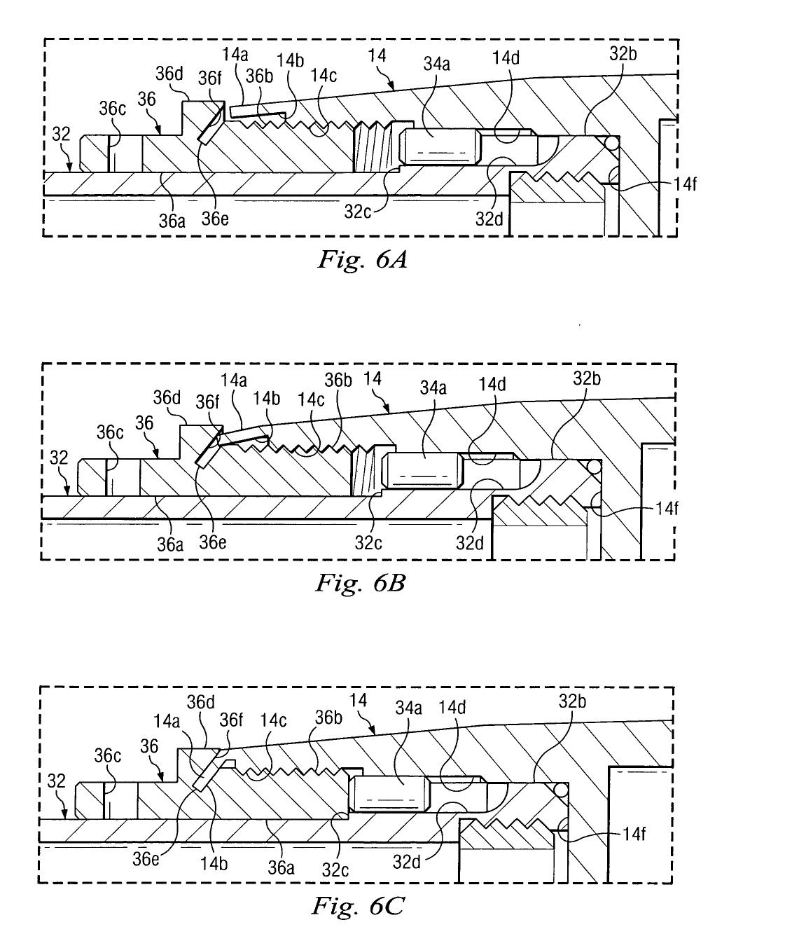

During assembly, and referring to FIGS. 6A through 6C with continuing reference to FIGS. 1 through 5, the distal portion 14a of the motor case 14 is initially in an uncrimped or undeformed condition so that the distal portion has a continuous profile and cross-section, tapering to the distal end of the motor case, as shown in FIG. 6A. The pins 34a and 34b are held in place in the slots 32d and 32e, respectively, and the raised-diameter end portion 32b of the collet housing 32 is inserted into the motor case 14 so that the pins 34a and 34b extend into the slots 14d and 14e, respectively.

The locking element 36 is slid over the outer surface of the collet housing 32 so that the collet housing extends through the bore 36a. The locking element 36 is inserted into the motor case 14, passing under the undercut 14b until the threaded portion 36b is able to engage the threaded portion 14c. The locking element 36 is then rotated to threadably engage the threaded portions 36b and 14c, thereby moving the locking element in a longitudinal direction, relative to the motor case 14 and towards the shoulder 32c. Rotation may be facilitated by inserting a portion of a tool, such as a torque wrench, into the hole 36c and manipulating the tool to rotate the locking element 36.

As the locking element 36 moves closer to the shoulder 32c, the distal end of the motor case 14 engages the camming surface 36f so that the distal portion 14a is forced downwards and begins to deform and extend into the channel 36e, as shown in FIG. 6B, thereby locking the motor case to the locking element. The relatively thin wall of the motor case 14, corresponding to the location of the undercut 14b, facilitates the plastic deformation of the distal portion 14a into the channel 36e. The difference between the above-described material hardnesses of the motor case 14 and the locking element 36 also facilitates the deformation of the distal portion 14a.

As the locking element 36 continues to be rotated, the distal portion 14a further deforms and extends into the channel 36e so that the distal end of the motor case 14 (or the distal end of the distal portion 14a) is radially offset from the engagement of the threaded portions 36b and 14c. The rotation of the locking element 36 also causes the walls of the channel 36e to torque the distal portion 14a so that the distal portion is twisted about the longitudinal axis of the motor case 14. Rotation of the locking element 36 is continued until the threaded portion 36b bottoms out, that is, until the threaded portions 36b and 14c are fully engaged, and/or until the proximal end of the locking element contacts the shoulder 32c and the distal end of the collet housing 32 contacts the wall 14f, as shown in FIG. 6C.

The locking element 36 may be threadably engaged with the motor case 14 in the above-described manner with or without a torque wrench. If a torque wrench is used, the torque reading provided by the torque wrench during the assembly and locking of the cylindrical housing 32 to the motor case 14 provides feedback as to the relative conditions of the locking element 36 and the distal portion 14a during the assembly. The torque reading shows an initial torque spike when the distal portion 14a is bent beyond the yield strength of the motor case material, indicating that the distal portion is plastically deforming while being forced into the channel 36e.

The torque reading is relatively constant as the distal portion 14a continues to be forced into the channel 36e and torqued about the longitudinal axis of the motor case 14, indicating that further threaded engagement between the portions 36b and 14c is possible and desired to further lock the motor case 14 to the locking element 36. The torque reading begins to appreciably increase after the threaded portion 36b bottoms out, that is, after the threaded portions 36b and 14c are fully engaged. At this point, rotation of the locking element 36 is stopped. Thus, the torque reading provides feedback as to the degree of threaded engagement between the locking element 36 and the motor case 14, and as to when rotation of the locking element 36 should cease. It is understood that this feedback may be a substitute for specifying a value to which the locking element 36 may be torqued.

If a torque wrench is not used during the above-described operation, the resistance to rotation provides tactile feedback as to the relative conditions of the locking element 36 and the distal portion 14a during the assembly. That is, the initial plastic deformation of the distal portion 14a into the channel 36e will be felt by the assembler/operator of the surgical instrument. After continued rotation of the locking element 36, the subsequent bottomed-out condition of the threaded portions 36b and 14c will be felt due to the appreciable increase in the resistance to further rotation. Thus, this tactile feedback indicates the degree of threaded engagement between the locking element 36 and the motor case 14.

In operation, the motor 12 receives high-pressure air via the hose assembly 15 to rotate a rotor shaft (not shown) that is coupled with the shaft 28 of the surgical instrument 10, as disclosed in detail in the above-incorporated co-pending patent application Ser. No. 10/200,683. Due to this coupling, the shaft 22 rotates, thereby rotating the dissection head 24, which may be applied against bone or other human tissue to cut or dissect the bone or tissue. Low-pressure exhaust air exits the motor 12 through an exhaust passage in the hose assembly 15.

While the surgical instrument 10 is dissecting the bone or other tissue, the instrument is subjected to a variety of static and/or dynamic (shock or vibrating) loads in a variety of directions. The collet housing 32 is prevented from rotating relative to the motor case 14, and vice versa, due to the contact between the pins 34a and 34b and the substantially aligned walls defined by the slots 32d and 14d, and 32e and 14e, respectively.

The collet housing 32 is prevented from sliding out of the distal end of the motor case 14a, in a direction away the motor 12, due to the contact between the shoulder 32c and the proximal end of the locking element 36. The locking element 36 is able to so hold the collet housing 32 because, inter alia, the adhesive applied to the threaded portions 14c and 36b prevents the locking element from disengaging from the motor case 14, especially when the surgical instrument is undergoing vibratory loading. The extension of the distal portion 14a into the channel 36e also prevents the locking element 36 from disengaging from the motor case 14 due to the contact between the distal portion and the walls of the channel. The radial offset between the distal end of the motor case 14 (or the distal end of the distal portion 14a) and the engagement of the threaded portions 36b and 14c, relative to the longitudinal axis of the motor case, further promotes resistance to disengagement. Thus, the locking element 36 is locked to the motor case 14 and, as a result, the collet housing 32 is locked to the motor case.

It is understood that the distal portion 14a operates to prevent disengagement between the threaded portions 14c and 36b, and therefore between the collet housing 32 and the motor case 14, even if the adhesive applied to the threaded portions has weakened or undergone performance degradation for any reason. Such reasons may include the repeated operation of the surgical instrument 10 for long periods of time, or the sterilization of the surgical instrument in an autoclave, during which time the adhesive is subjected to high-temperature cycling. Thus, due to the extension of the distal portion 14a into the channel 36e, the connection between the motor case 14 and the locking element 36 is more resistant to disengagement.

During disassembly, a predetermined amount of torque is applied to the locking element 36 to untwist and bend the distal portion 14a back to or near its initial condition so that the locking element and the collet housing 32 may be disengaged from the motor case 14. The motor case 14 may be a disposable article, that is, it may be discarded and a new motor case may be used when re-assembling the surgical instrument 10.

### Variations

It is understood that variations may be made in the foregoing without departing from the scope of the disclosure. These variations include the following:

1. The locking element 36 may be used to lock any type of cylindrical structure to any type of tubular member. For example, the cylindrical structure could extend through the locking element 36 and be inserted into the tubular member. The locking element 36 could be threadably engaged with internal threads formed in the inner wall of the tubular member, thereby locking the cylindrical structure to the tubular member.

2. The distal portion 14a may be a separate component from and connected to the remaining portion of the motor case 14. Thus, after the distal portion 14a has been bent back and the locking element 36 has been disengaged from the motor case 14, the distal portion may be disconnected from the rest of the motor case and a new distal portion may be used with the motor case when re-assembling the surgical instrument 10.

3. The motor case 14 and/or the distal portion 14a may be designed for reuse, that is, the components could accommodate the repeated assembly and disassembly of the locking element 36 to the distal portion. Further, the locking element 36 and the motor case 14 could be modified so that the distal portion 14a only elastically deforms. It is understood that reuse of the motor case 14 would be facilitated with such a modification.

4. The distal portion 14a could be designed to break when a predetermined amount of torque is applied to the locking element 36 to remove the locking element from the motor case 14.

5. The ring 36d and the channel 36e could be modified so that the channel 36e extends in a different angular direction. For example, the angular direction of the channel 36e could be modified so that the distal portion 14a is forced radially outwards, that is, flares out away from the bore 36a, when the locking element 36 threadably engages the motor case 14.

6. In addition to the pneumatic motor 12, other types of motors using electricity or other motive forces may be used with the surgical instrument 10. If other types of motors are employed, it is understood that the hose assembly 15 may be removed from the surgical instrument 10.

7. Any foregoing spatial references, such as “upper,” “between,” “front,” “right side,” “side,” 37 above,” “beneath,” etc., are for the purpose of illustration only and do not limit the specific spatial orientation of the structure described above.

The preceding specific embodiments are illustrative of the practice of the invention. It is to be understood, therefore, that other expedients known to those skilled in the art or disclosed herein, may be employed without departing from the invention or the scope of the appended claims. For example, the present invention is not limited to instruments and methods for connecting different components of a dissection tool assembly. The present invention is also not limited to instruments and associated methods for dissecting bone or other tissue per se, but may find further application in other surgical instruments used in other operations such as, for example, dental procedures. The present invention further includes within its scope the methods of making, assembling and using the surgical instrument 10 described hereinabove.

It is intended that the scope of the disclosure be defined by the claims appended hereto and their equivalents. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts a nail and a screw are equivalent structures.

What is claimed is:

1. A surgical instrument comprising:
a motor case;
a collet housing, at least a portion of which is inserted into the motor case; and
a locking element for locking the collet housing to the motor case, the locking element comprising a bore through which the collet housing extends, and a circumferentially-extending channel formed therein and into which a distal portion of the motor case extends.

2. The surgical instrument of claim 1 wherein the locking element is threadably engaged with the motor case and wherein the extension of the distal portion into the channel provides a resistance to disengagement of the locking element from the motor case.

3. The surgical instrument of claim 2 wherein the resistance to disengagement of the locking element from the motor case provides a resistance to disengagement of the collet housing from the motor case.

4. The surgical instrument of claim 2 wherein the collet housing comprises a raised-diameter end portion defining a shoulder and wherein an end of the locking element engages the shoulder to provide a resistance to disengagement of the collet housing from the motor case.

5. The surgical instrument of claim 2 wherein the locking element is comprised of material having a higher material hardness than the material of the distal portion so that a predetermined torque overcomes the resistance to disengagement of the locking element from the motor case.

6. The surgical instrument of claim 2 wherein the motor case is disposable.

7. The surgical instrument of claim 2 wherein, after the resistance to disengagement of the locking element from the motor case is overcome, the locking element can be disengaged from the motor case and then threadably engaged with the motor case.

8. The surgical instrument of claim 2 further comprising a ring extending circumferentially around the locking element, the ring defining a side wall in which the channel is formed.

9. The surgical instrument of claim 8 wherein the motor case has a distal end and wherein the channel defines a camming surface that engages the distal end when the locking element moves in a longitudinal direction relative to the motor case.

10. The surgical instrument of claim 9 wherein the channel extends in an angular direction towards the bore.

11. The surgical instrument of claim 9 wherein the channel extends in an angular direction away from the bore.

12. The surgical instrument of claim 8 wherein the distal portion of the motor case is forced into the channel when the locking element moves in a longitudinal direction relative to the motor case.

13. The surgical instrument of claim 12 further comprising an undercut formed in the L distal portion of the motor case to facilitate the forcing of the distal portion into the channel.

14. The surgical instrument of claim 12 wherein adhesive is disposed in the channel.

15. The surgical instrument of claim 12 wherein the distal portion of the motor case is forced further into the channel and twisted when the locking element continues to move in the longitudinal direction relative to the motor case.

16. The surgical instrument of claim 15 wherein the extension of the distal portion into the channel provides feedback as to the degree of thread engagement between the locking element and the motor housing.

17. A surgical instrument comprising:
a tubular member;
a cylindrical structure, at least a portion of which is inserted into the tubular member;
a locking element for locking the cylindrical structure to the tubular member, the locking element threadably engaged with the tubular member; and
means for deforming a distal portion of the tubular member to provide a resistance to disengagement of the locking element from the tubular member.

18. The surgical instrument of claim 17 wherein the deforming means comprises a circumferentially-extending channel formed in the locking element and into which the distal portion extends.

19. The surgical instrument of claim 17 wherein the resistance to disengagement of the locking element from the tubular member provides a resistance to disengagement of the cylindrical structure from the tubular member.

20. The surgical instrument of claim 17 wherein the cylindrical structure comprises a raised-diameter end portion defining a shoulder and wherein an end of the locking element engages the shoulder to provide a resistance to disengagement of the cylindrical structure from the tubular member.

21. The surgical instrument of claim 17 wherein the locking element is comprised of material having a higher material hardness than the material of the distal portion so that a predetermined torque overcomes the resistance to disengagement of the locking element from the tubular member.

22. The surgical instrument of claim 17 wherein the tubular member is disposable.

23. The surgical instrument of claim 17 wherein, after the resistance to disengagement of the locking element from the tubular member is overcome, the locking element can be disengaged from the tubular member and then threadably engaged with the tubular member.

24. The surgical instrument of claim 18 wherein the deforming means further comprises a ring extending circumferentially around the locking element, the ring defining a side wall in which the channel is formed.

25. The surgical instrument of claim 24 wherein the tubular member has a distal end and wherein the channel defines a camming surface that engages the distal end when the locking element moves in a longitudinal direction relative to the tubular member.

26. The surgical instrument of claim 25 wherein the channel extends in an angular direction, wherein the tubular member is a motor case, and wherein the cylindrical structure is a collet housing.

27. The surgical instrument of claim 24 wherein the distal portion of the tubular member is forced into the channel when the locking element moves in a longitudinal direction relative to the tubular member.

28. The surgical instrument of claim 27 wherein the deforming means further comprises an undercut formed in the distal portion of the tubular member to facilitate the forcing of the distal portion into the channel.

29. The surgical instrument of claim 27 wherein the distal portion of the tubular member is forced further into the channel and twisted when the locking element continues to move in the longitudinal direction relative to the tubular member.

30. The surgical instrument of claim 29 wherein the extension of the distal portion into the channel-provides feedback as to the degree of thread engagement between the locking element and the motor housing.

31. A method of assembling a surgical instrument, the method comprising:
inserting at least a portion of a cylindrical structure into a tubular member; and
moving a locking element in a longitudinal direction relative to the tubular member so that a distal portion of the tubular member extends into a circumferentially-extending channel formed in the locking element to lock the cylindrical structure to the tubular member.

32. The method of claim 31 wherein the locking element is threadably engaged with the tubular member and wherein the extension of the distal portion into the channel provides a resistance to disengagement of the locking element from the tubular member.

33. The method of claim 32 wherein the tubular member is a motor case.

34. The method of claim 33 wherein the cylindrical structure is a collet housing.

35. The method of claim 32 wherein the tubular member has a distal end and wherein, during the step of moving, the distal end engages a camming surface defined by the channel.

36. The method of claim 35 wherein, during the step of moving, the distal portion is forced into the channel.

37. The method of claim 36 wherein, during the step of moving, the distal portion is twisted.

38. The method of claim 32 further comprising determining the degree of thread engagement between the locking element and the motor housing.

39. The method of claim 32 further comprising applying a predetermined torque to overcome the resistance to disengagement.

40. The method of claim 39 further comprising replacing the first-mentioned tubular member with another tubular member.
